(19) United States
(12) Patent Application Publication
(10) Pub. No.: US 2007/0057212 A1
(43) Pub. Date: Mar. 15, 2007

(54) Flush valve diaphragm filter

(75) Inventor: Hsiao Hao-Yao, Taiping City (TW)

Correspondence Address: TROXELL LAW OFFICE PLLC, SUITE 1404, 5205 LEESBURG PIKE, FALLS CHURCH, VA, 22041, US

(73) Assignee: Globe Union Industrial Corp.

(21) Appl. No.: 11/221,715

(22) Filed: Sep. 9, 2005

(51) Int. Cl. F16K 31/12

(52) U.S. Cl. 251/40

(57) ABSTRACT

A flush valve diaphragm filter has a filter body forming a recess section for being assembled to a diaphragm. The filter body defines a main passageway longitudinally therethrough and a plurality of branch passageways transversely therethrough. The branch passageways communicate with the main passageway, and have diameters smaller than the diameter of the main passageway. The flush valve diaphragm filter effectively debases the ratio of fluid passage being fully clogged, and guides strip-like fibre and lichens to exterior. Correspondingly water filtering function is enhanced.

### BACKGROUND OF THE INVENTION

1. Field of the Invention

The present invention relates to a flush valve diaphragm filter, and particularly to a flush valve diaphragm filter used in sanitation equipments, like urinals and water closets, for filtering water thereby preventing particulates from clogging water passageway.

2. Related Art

Flush valve diaphragms are often mounted on sanitation equipments, like urinals and water closets. As shown in FIG. 1, the flush valve 8 has a diaphragm 80 sealing off a central passageway 810 of a barrel section 81. The barrel section 81 defines a bypass 801 serving as fluid communication between an inlet 82 and the barrel section 81. Water flows from the inlet 82 and the bypass 801, into the barrel section 81. Fluid pressure forces the diaphragm 80 in place to close the central passageway 810. In the closed position, water is stored in the barrel section 81 and is prohibited to flow out of an outlet 86. When a handle 84 of the flush valve 8 moves to drive a stem 85, water pressure difference are produced in the barrel section 81. Water stored in the barrel section 81 flows through the outlet 86 for flushing.

Fluid often brings particulates, such as dust, rust, sundries and etc., to the barrel section 81, clogging the bypass 801 and therefore affecting the performance of the diaphragm 80. U.S. patent application Ser. No. 10/615,614 discloses a bypass orifice filter insert for use in a flush valve diaphragm. Referring to FIG. 2, the bypass orifice filter insert 9 longitudinally defines a slit 90 therethrough. The slit 90 has a first portion with relatively large diameter and extending into a barrel section, and a second portion with relatively small diameter. The bypass orifice filter insert 9 can filter water through the slit 90, solving the problem of clogging the water passage.

However, the bypass orifice filter insert 9 in FIG. 2 does not effectively overcome this defect. Further referring to FIGS. 3 and 4, the slit 90 is separate. The first portion 901 and the second portion 902 share a common center line, and are arranged in the same direction as water flowing. So dust, rust, grain sundries, fibre and lichens may directly clog the second portion 902 with relatively small diameter, and correspondingly, water cannot flow into the first portion 901 with relatively large diameter and cannot flush a water bowl.

### SUMMARY OF THE INVENTION

Accordingly, an object of the present invention is to provide a flush valve diaphragm filter effectively preventing particulates from clogging fluid passageway.

The flush valve diaphragm filter comprises a filter body forming a recess section. The filter body defines a main passageway longitudinally therethrough and a plurality of branch passageways transversely therethrough. The branch passageways communicate with the main passageway, and have diameter smaller than the diameter of the main passageway.

### BRIEF DESCRIPTION OF THE DRAWINGS

FIG. 1 is a partial sectional view of a prior art flush valve with a conventional diaphragm assembly.

FIG. 2 is a plane view of a flush valve diaphragm assembly of U.S. patent application Ser. No. 10/615,614.

FIGS. 3 and 4 schematically show that water is filtered by conventional diaphragm assembly in FIG. 2.

FIG. 5 is a perspective view of a flush valve diaphragm filter in accordance with the present invention.

FIG. 6 is a partial sectional view of the flush valve diaphragm filter of FIG. 5.

FIG. 7 is a sectional view of the flush valve diaphragm filter being assembled on a bypass of a diaphragm filter.

FIGS. 8 and 9 schematically show water being filtered by the flush valve diaphragm filter of FIG. 7.

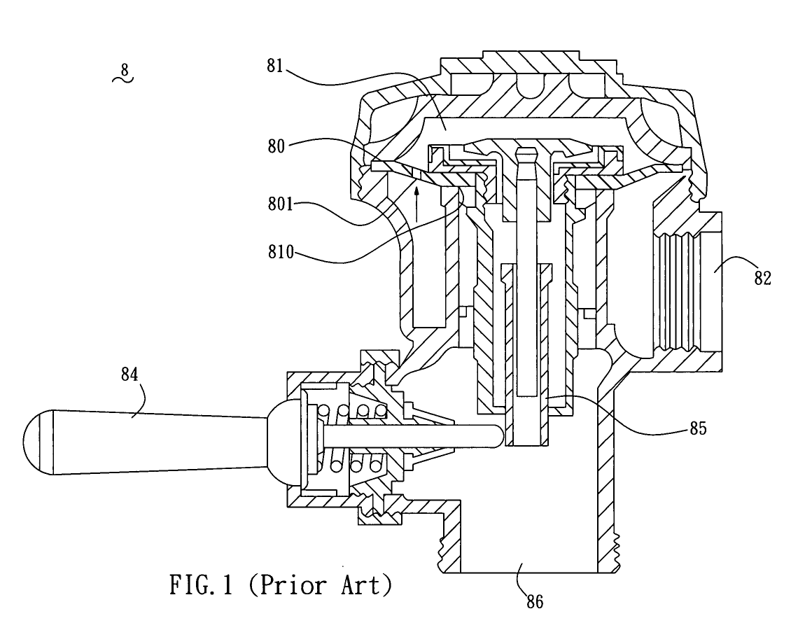

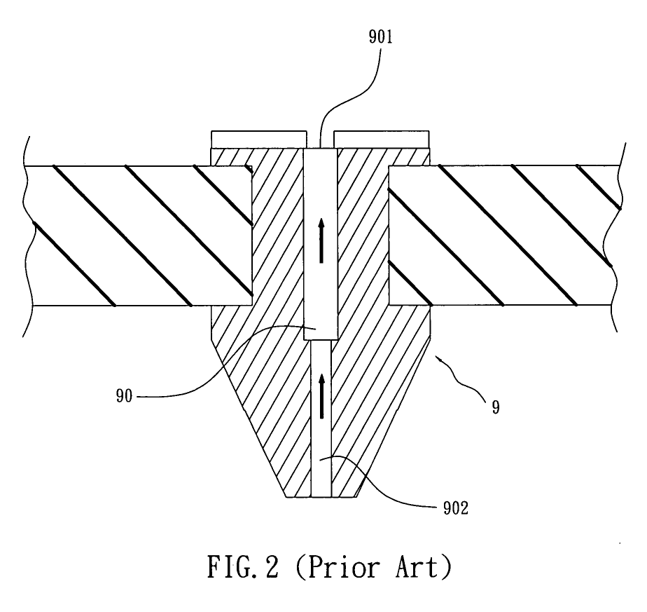

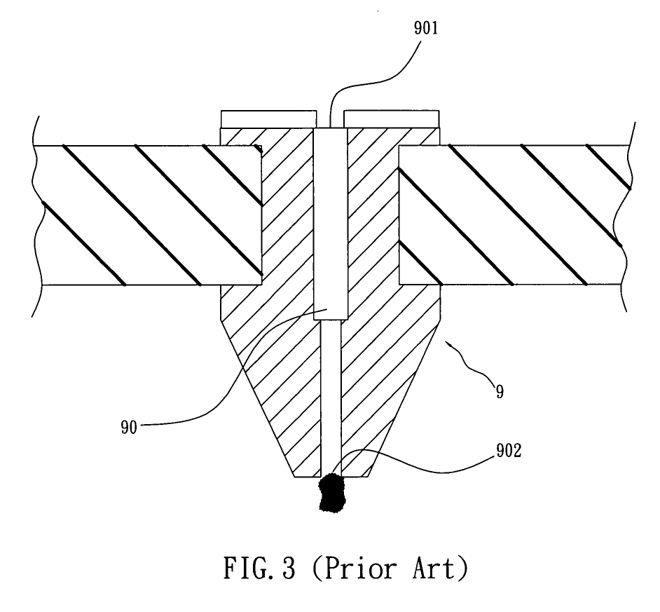

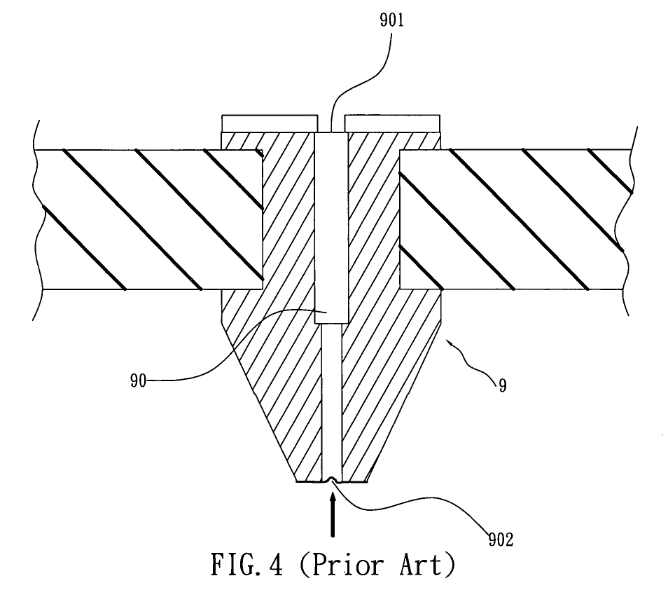

### DESCRIPTION OF THE PREFERRED EMBODIMENTS

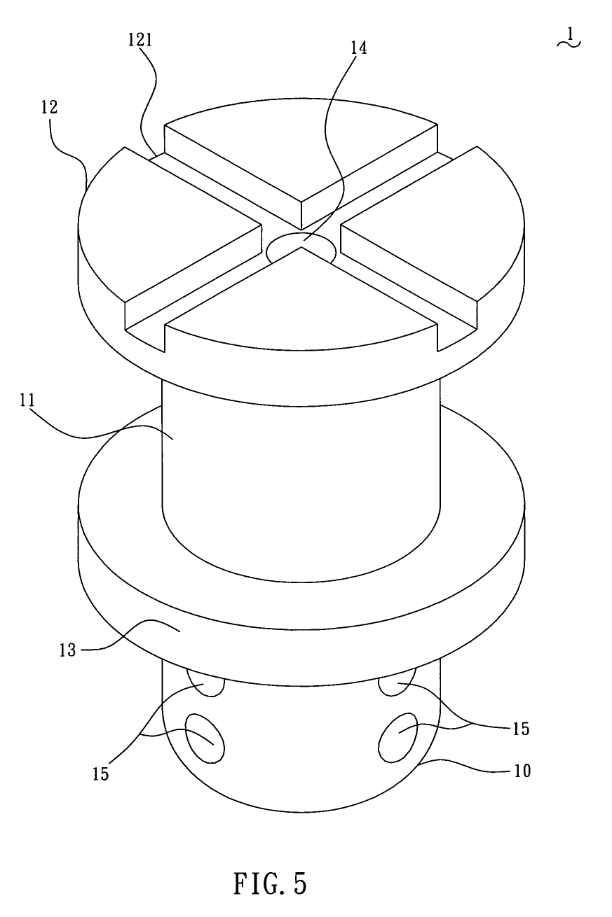

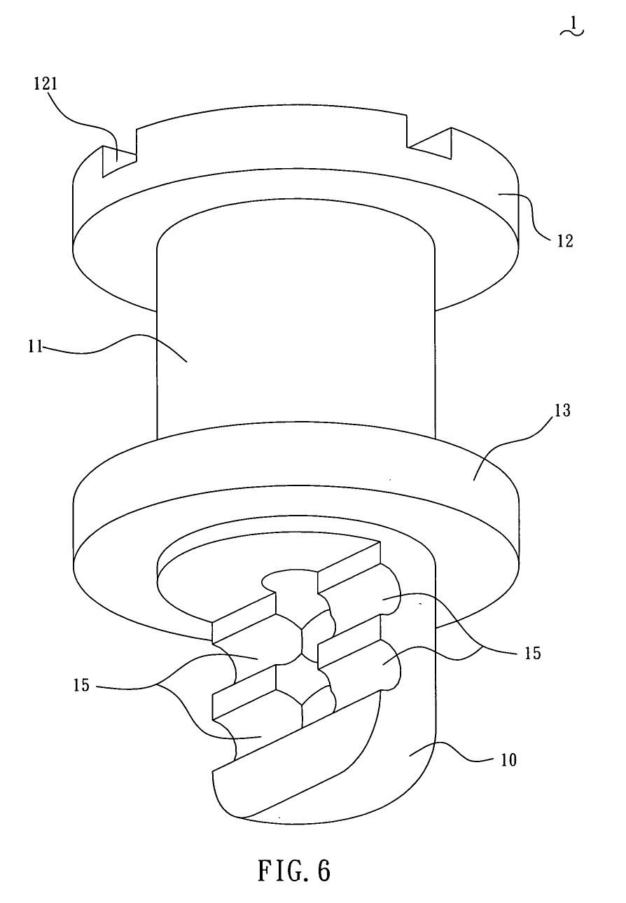

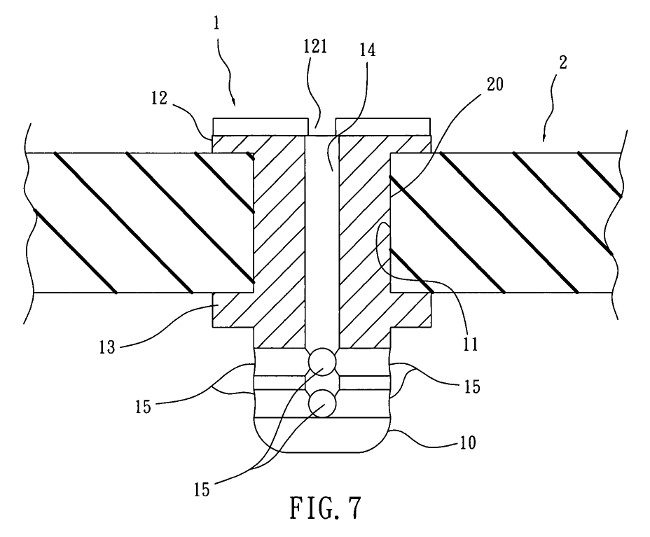

With reference to FIGS. 5 and 6, a flush valve diaphragm filter 1 in accordance with the present invention comprises a filter body 10 defining an annular recess section 11 for corresponding to a bypass 20 of a diaphragm 2 (shown in FIG. 7). In one embodiment, the diaphragm 2 is a cylinder. The recess section 11 forms a first flange 12 on a top thereof and a second flange 13 on a bottom thereof. The first flange 12 defines a cross-like groove 121 on a top surface thereof for guiding fluid. The filter body 10 defines a main passageway 14 longitudinally therethrough and generally in a center thereof. Eight branch passageways 15 are transversely formed below the second flange 13 and have smaller diameter compared to the main passageway 14. The branch passageways 15 respectively communicate with the main passageway 14 and are arranged in two layers symmetric to each other. The branch passageways 15 on each layer are spaced the same distance 90° from each other. In one embodiment, the branch passageways 15 are bilaterally symmetrical and are arranged in a parallel or an unparallel manner. In another embodiment, the branch passageways 15 are bilaterally unsymmetrical and are arranged in a parallel or an unparallel manner. With continued reference to FIG. 7, during the flush valve diaphragm filter 1 is assembled on the bypass 20 of the diaphragm 2, the bypass 20 is tilted and slightly expands to enclose the recess section 11 due to flexibility of the diaphragm 2.

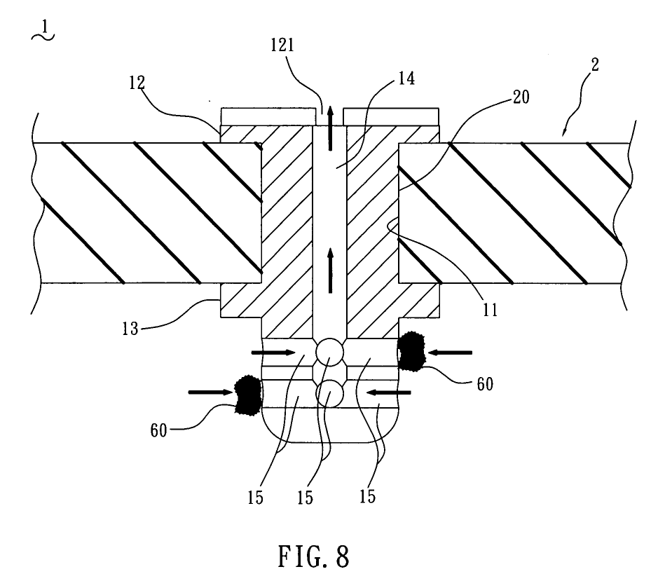

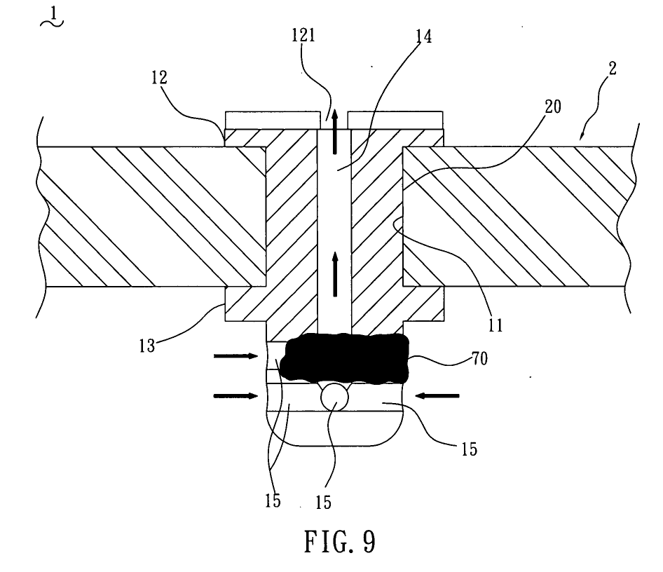

With reference to FIGS. 8 and 9, each branch passageway 15 has filtering function. Water flows through and is filtered by multiple branch passageways 15. Sundries in water have to block all the branch passageways 15 to block water entirely, otherwise unclogged branch passageways 15 may allow water flowing therethrough and into the main passageway 14. For example, even if particulates 60 in water block two branch passageways 15, other branch passageways 15 can provide fluid passage communicating to the main passageway 14 (shown in FIG. 8). Similarly, the branch passageways 15 may guide small strip-like fibre and lichens to exterior owning to transverse arrangement thereof, thereby avoiding the main passageway 14 stuffing. Even if large strip-like fibre and lichens block two branch passageways 15, other branch passageways 15 may still lead fluid to the main passageway 14. The branch passageways 15 effectively debase the ratio of fluid passage being fully clogged, and therefore enhance water filtering ability.

It is understood that the invention may be embodied in other forms without departing from the spirit thereof. Thus, the present examples and embodiments are to be considered in all respects as illustrative and not restrictive, and the invention is not to be limited to the details given herein.

1. A flush valve diaphragm filter, adapted to be assembled on a diaphragm bypass of a flush valve, comprising a filter body forming a recess section, and defining:
a main passageway longitudinally therethrough; and
a plurality of branch passageways transversely therethrough and communicating with the main passageway;
wherein the branch passageways have diameters smaller than a diameter of the main passageway.

2. The flush valve diaphragm filter as claimed in claim 1, wherein the branch passageways are bilaterally symmetrical and are arranged in a parallel or an unparallel manner.

3. The flush valve diaphragm filter as claimed in claim 1, wherein the branch passageways are bilaterally unsymmetrical and are arranged in a parallel or an unparallel manner.

4. The flush valve diaphragm filter as claimed in claim 1, wherein the recess section is annular, and forms a first flange on a top thereof and a second flange on a bottom thereof.

5. The flush valve diaphragm filter as claimed in claim 4, wherein the first flange defines a groove on a top surface thereof.

6. The flush valve diaphragm filter as claimed in claim 5, wherein the groove is cross-like.

7. The flush valve diaphragm filter as claimed in claim 1, wherein the diaphragm is a cylinder, and wherein eight branch passageways are distributed in two layers symmetric to each other, and branch passageways on each layer are spaced the same distance 90° from each other.
